(19) United States
(12) Patent Application Publication
(10) Pub. No.: US 2025/0301275 A1
(43) Pub. Date: Sep. 25, 2025

(54) SIGNAL PROCESSING SYSTEM, SIGNAL PROCESSING METHOD, AND NON-TRANSITORY COMPUTER READABLE MEDIUM

(71) Applicant: CLEPSEADRA, INC., Tokyo (JP)

(72) Inventors: Homare KON, Tokyo (JP); Yu MAENO, Tokyo (JP)

(73) Assignee: CLEPSEADRA, INC., Tokyo (JP)

(21) Appl. No.: 18/866,679

(22) PCT Filed: May 22, 2023
(86) PCT No.: PCT/JP2023/018937

§ 371 Date: Nov. 18, 2024

(30) Foreign Application Priority Data
May 26, 2022 (JP) 2022-085961

(51) Int. Cl. H04S 7/00; H04R 29/00; H04S 3/00

(52) U.S. Cl. CPC H04S 7/30; H04R 29/001; H04R 29/004; H04S 3/008; H04S 2400/01; H04S 2400/15

(57) ABSTRACT

A signal processing system including: a measurement device configured to acquire measurement data regarding a transfer characteristic; a first acquisition device configured to acquire a first audio signal; and a control device configured to be connected to each of the measurement device and the first acquisition device through a network, wherein the control device corrects the first audio signal on a basis of the measurement data acquired by the measurement device and generates a second audio signal.

### TECHNICAL FIELD

The present disclosure relates to a signal processing system, a signal processing method, and a program.

### BACKGROUND ART

In recent years, binaural recording has attracted attention. The binaural recording is a technique of recording sounds transmitted to the eardrums of both ears of a human. For example, mics installed in the external auditory canals of both ears are used for binaural recording. The reproduction of binaurally recorded sounds is also referred to as binaural reproduction. Binaural reproduction with earphones, headphones, or the like makes it possible to reproduce stereophonic and realistic sounds that make a listener feel as if the listener was present in the place of recording.

A variety of technologies related to binaural recording and binaural reproduction have been developed. For example, Patent Literature 1 below proposes a binaural recording device including mics for noise cancellation provided outside earphones held on ears by inserting earpieces to the external auditory canals.

### CITATION LIST

### Patent Literature

Patent Literature 1: JP 2009-49947A

### SUMMARY OF INVENTION

### Technical Problem

It has not, however, been so long since the development of the technology described in Patent Literature 1 above, leaving room for improvement from various perspectives.

Accordingly, the present disclosure has been devised in view of the problem described above. An object of the present disclosure is to provide a mechanism that makes it possible to perform binaural recording more easily.

### Solution to Problem

To solve the above described problem, according to an aspect of the present disclosure, there is provided a signal processing system comprising: a measurement device configured to acquire measurement data regarding a transfer characteristic; a first acquisition device configured to acquire a first audio signal; and a control device configured to be connected to each of the measurement device and the first acquisition device through a network, wherein the control device corrects the first audio signal on a basis of the measurement data acquired by the measurement device and generates a second audio signal.

The signal processing system may further comprise: a reproduction device configured to reproduce an audio signal; and a second acquisition device configured to acquire an audio signal, wherein the measurement device may transmit a fourth audio signal corresponding to a third audio signal reproduced by the reproduction device to the control device as the measurement data, the fourth audio signal being acquired by the second acquisition device.

The measurement device may transmit information indicating a characteristic of the reproduction device or information indicating a characteristic of the second acquisition device to the control device as the measurement data.

The measurement device may transmit information indicating a method for the second acquisition device to acquire the fourth audio signal to the control device as the measurement data.

The signal processing system may comprise: the two reproduction devices; and the two second acquisition devices, wherein the two reproduction devices and the two second acquisition devices, and the measurement device may be connected in a wired manner through a 5-pole plug including two terminals that transmit the third audio signals which are inputted to the two reproduction devices, two terminals that transmit the fourth audio signals which are outputted from the two second acquisition devices, and one ground terminal.

The measurement device may transmit a fifth audio signal acquired by the second acquisition device to the control device as the measurement data at a timing at which the reproduction device does not reproduce an audio signal, and the control device may correct the first audio signal further on a basis of the fifth audio signal.

The measurement device may include a communication interface capable of cellular communication and may cause the communication interface to transmit the measurement data to the control device.

The measurement device may determine whether or not the acquired measurement data satisfies a predetermined condition, and may transmit only the measurement data determined to satisfy the predetermined condition to the control device.

The signal processing system may further comprise a terminal device capable of receiving an input of information made by a user and outputting information to the user, wherein the terminal device may receive and outputs information regarding acquisition of the measurement data, and the measurement device may acquire the measurement data by being triggered by an input of information for an instruction to acquire the measurement data to the terminal device.

The terminal device may output information indicating an action to be executed by the user before the acquisition of the measurement data.

In a case where an action to be executed by the user before the acquisition of the measurement data is not executed, the terminal device may refuse to receive the information for the instruction to start to acquire the measurement data.

The control device may generate the second audio signal by calculating the transfer characteristic on the basis of the measurement data and convolving an inverse characteristic of the calculated transfer characteristic with the first audio signal.

To solve the above described problem, according to another aspect of the present disclosure, there is provided a signal processing method that is executed by a computer, the signal processing method comprising: acquiring measurement data regarding a transfer characteristic through a network; acquiring a first audio signal through the network, the first audio signal being acquired by a first acquisition device; and correcting the first audio signal on a basis of the measurement data and generating a second audio signal.

To solve the above described problem, according to another aspect of the present disclosure, there is provided a program for causing a computer to execute acquiring measurement data regarding a transfer characteristic through a network, acquiring a first audio signal through the network, the first audio signal being acquired by a first acquisition device, and correcting the first audio signal on a basis of the measurement data and generating a second audio signal.

### Advantageous Effects of Invention

As described above, according to the present disclosure, there is provided a mechanism that makes it possible to perform binaural recording more easily.

### BRIEF DESCRIPTION OF DRAWINGS

FIG. 1 is a diagram illustrating an example of a configuration of a signal processing system according an embodiment of the present disclosure.

FIG. 2 is a diagram illustrating an example of a configuration of a measurement system according to the present embodiment.

FIG. 3 is a diagram illustrating an example of a configuration of a recording system according to the present embodiment.

FIG. 4 is a diagram illustrating an example of a configuration of a control device according to the present embodiment.

FIG. 5 is a diagram for describing measurement of a transfer characteristic according to the present embodiment.

FIG. 6 is a diagram for describing binaural recording according to the present embodiment.

FIG. 7 is a diagram for describing binaural reproduction according to the present embodiment.

FIG. 8 is a sequence diagram illustrating an example of a flow of processing that is executed by the signal processing system according to the present embodiment.

FIG. 9 is a diagram schematically illustrating an example of a hardware configuration of a measurement earphone and a measurement mic.

FIG. 10 is a diagram for describing an example of a connection mode between the measurement earphone and the measurement mic, and a measurement device.

FIG. 11 is a sequence diagram illustrating an example of a flow of processing that is executed by a signal processing system according to a first modification example.

FIG. 12 is a sequence diagram illustrating an example of a flow of processing that is executed by a signal processing system according to a second modification example.

### DESCRIPTION OF EMBODIMENTS

Hereinafter, referring to the appended drawings, preferred embodiments of the present disclosure will be described in detail. It should be noted that, in this specification and the appended drawings, structural elements that have substantially the same function and structure are denoted with the same reference numerals, and repeated explanation thereof is omitted.

### 1. Configuration Example

### (1) Configuration of Signal Processing System 1

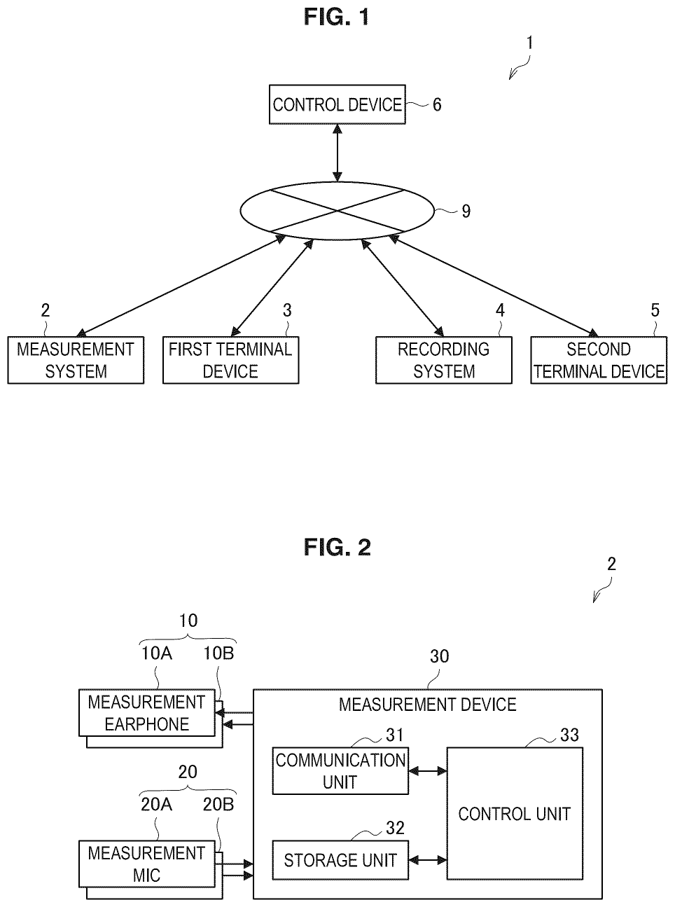

FIG. 1 is a diagram illustrating an example of a configuration of a signal processing system 1 according an embodiment of the present disclosure. As illustrated in FIG. 1, the signal processing system 1 includes a measurement system 2, a first terminal device 3, a recording system 4, a second terminal device 5, and a control device 6. The measurement system 2, the first terminal device 3, the recording system 4, the second terminal device 5, and the control device 6 are connected through a network 9 and are communicable with each other. The network 9 may include a public network in addition to a local network. For example, the network 9 may include a telephone network, the Internet, or the like.

The measurement system 2 is a system that acquires measurement data described below. The measurement system 2 will be described in detail below.

The first terminal device 3 is a device that performs processing related to the acquisition of measurement data by the measurement system 2. The first terminal device 3 is capable of receiving an input of information made by a user and outputting information to the user. For example, the first terminal device 3 displays a UI (User Interface) screen for operating the measurement system 2 to notify a user of information and receive an operation from the user. As an example, the first terminal device 3 may be implemented by a smartphone or the like.

The recording system 4 is a system that performs binaural recording. The recording system 4 will be described in detail below.

The second terminal device 5 is a device that acquires binaurally recorded content (i.e., audio signal) and performs various kinds of processing. The second terminal device 5 is capable of outputting information to a user and receiving an input of information made by the user. For example, the second terminal device 5 acquires content binaurally recorded and subjected to correction processing by the control device 6, and binaurally reproduces the content from reproduction earphones connected to the second terminal device 5. As an example, the second terminal device 5 may be implemented by a PC (Personal Computer).

The control device 6 is a device that performs correction processing for increasing the quality of content binaurally recorded by the recording system 4. If described in detail, the control device 6 corrects, on the basis of measurement data acquired by the measurement system 2, content binaurally recorded by the recording system 4. The control device 6 then transmits the corrected content to the second terminal device 5.

### (2) Configuration of Measurement System 2

FIG. 2 is a diagram illustrating an example of a configuration of the measurement system 2 according to the present embodiment. As illustrated in FIG. 2, the measurement system 2 includes measurement earphones 10 (10A and 10B), measurement mics (microphones) 20 (20A and 20B), and a measurement device 30. The measurement system 2 includes the two measurement earphones 10 and the two measurement mics 20 for both respective ears.

### —Measurement Earphones 10

Each of the measurement earphones 10 is a sound output device that reproduces an audio signal. The measurement earphone 10 converts an inputted audio signal to sound and emits the sound to the surrounding space. The measurement earphone 10 may be connected to the measurement device 30 through a variety of devices such as a DAC (Digital Analog Converter) and an amplifier that are each related to the reproduction of an audio signal. The measurement earphone 10 is used for the measurement of transfer characteristics described below. Here, the measurement earphone 10 is an example of a reproduction device according to the present embodiment. The reproduction device may include any sound output device such as a speaker in addition to an earphone.

### —Measurement Mics 20

Each of the measurement mics 20 is a sound input device that acquires an audio signal. The measurement mic 20 converts sound in the surrounding space to an audio signal and outputs the converted audio signal. The measurement mic 20 may be connected to the measurement device 30 through a variety of devices such as an ADC (Analog Digital Converter) and an amplifier that are each related to the acquisition of an audio signal. The measurement mic 20 is used for the measurement of transfer characteristics. The measurement mic 20 may be configured as any type of sound input device such as a dynamic mic, a MEMS (Micro Electro Mechanical Systems) mic, a capacitor mic, or a laser mic. It should be noted that a so-called electret capacitor mic including an electret element for a diaphragm, a back electrode, or a back chamber may be used as the capacitor mic in addition to a type of mic in which a diaphragm receives a direct-current voltage from the outside. Here, the measurement mic 20 is an example of a second acquisition device according to the present embodiment.

### —Measurement Device 30

The measurement device 30 is a device that performs processing related to the acquisition of measurement data. As illustrated in FIG. 2, the measurement device 30 includes a communication unit 31, a storage unit 32, and a control unit 33.

The communication unit 31 is a communication interface that communicates with another device in a wired or wireless manner. The communication unit 31 performs communication compliant with any communication standard. An example of the communication standard includes a LAN (Local Area Network), Wi-Fi (registered trademark), Bluetooth (registered trademark), a cellular communication standard such as 4G or 5G, a USB (Universal Serial Bus), or the like.

In particular, the communication unit 31 functions as a first communication unit that communicates with the measurement earphone 10 and the measurement mic 20. The communication unit 31 serving as the first communication unit is a wired or wireless audio interface. The communication unit 31 serving as the first communication unit transmits and receives an audio signal to and from the measurement earphone 10 or the measurement mic 20.

In addition, the communication unit 31 functions as a second communication unit that communicates with the first terminal device 3. The communication unit 31 serving as the second communication unit may be a communication interface that is connectable to a local network constructed in compliance with Wi-Fi or the like.

In addition, the communication unit 31 functions as a third communication unit that communicates with the control device 6. The communication unit 31 serving as the third communication unit may be a communication interface capable of cellular communication. That is, the measurement device 30 may include a SIM (Subscriber Identity Module) card for cellular communication.

The storage unit 32 stores various kinds of information. The storage unit 32 stores data in a predetermined storage medium and reads out data from the predetermined storage medium. Examples of the predetermined storage medium include a non-volatile storage medium such as a flash memory. For example, the storage unit 32 stores acquired measurement data.

The control unit 33 functions as an arithmetic processing device and controls an overall operation of the measurement device 30 in accordance with a variety of programs. The control unit 33 is implemented, for example, by an electronic circuit such as a CPU (Central Processing Unit) or a DSP (Digital Signal Processor). It should be noted that the control unit 33 may include a ROM (Read Only Memory) that stores a program, an operation parameter, and the like to be used and a RAM (Random Access Memory) that temporarily stores a parameter and the like which appropriately change. The control unit 33 controls various kinds of processing for acquiring measurement data.

### (3) Configuration of Recording System 4

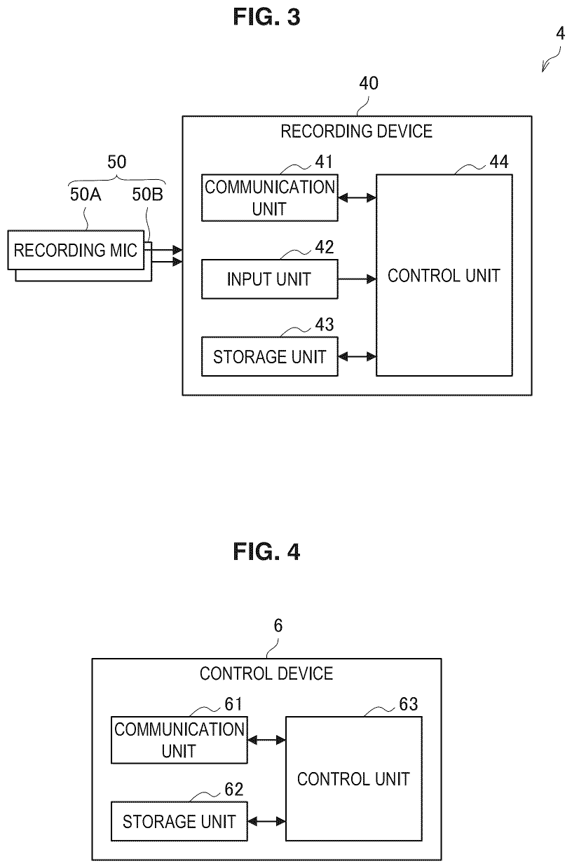

FIG. 3 is a diagram illustrating an example of a configuration of the recording system 4 according to the present embodiment. As illustrated in FIG. 3, the recording system 4 includes recording mics 50 (50A and 50B) and a recording device 40. The recording system 4 includes the two recording mics 50 for both respective ears.

### —Recording Mics 50

Each of the recording mics 50 is a sound input device that acquires an audio signal. A configuration of the recording mic 50 is similar to that of the measurement mic 20. The recording mics 50 are used for binaural recording. Here, the recording mic 50 is an example of a first acquisition device according to the present embodiment.

### —Recording Device 40

The recording device 40 is a device that performs processing related to the acquisition of recording data. The recording data includes content binaurally recorded by the recording mics 50. As illustrated in FIG. 3, the recording device 40 includes a communication unit 41, and input unit 42, a storage unit 43, and a control unit 44.

The communication unit 41 is a communication interface that communicates with another device in a wired or wireless manner. The communication unit 41 performs communication compliant with any communication standard. An example of the communication standard includes a LAN (Local Area Network), Wi-Fi (registered trademark), Bluetooth (registered trademark), a cellular communication standard such as 4G or 5G, a USB (Universal Serial Bus), or the like.

In particular, the communication unit 41 functions as a first communication unit that communicates with the recording mic 50. The communication unit 41 serving as the first communication unit is a wired or wireless audio interface. The communication unit 41 serving as the first communication unit transmits and receives an audio signal to and from the recording mic 50.

In addition, the communication unit 41 functions as a second communication unit that communicates with the second terminal device 5. The communication unit 41 serving as the second communication unit may be a communication interface that is connectable to a local network constructed in compliance with Wi-Fi or the like.

In addition, the communication unit 41 functions as a third communication unit that communicates with the control device 6. The communication unit 41 serving as the third communication unit may be a communication interface capable of cellular communication. That is, the recording device 40 may include a SIM (Subscriber Identity Module) card for cellular communication.

The input unit 42 receives inputs of various kinds of information from a user. The input unit 42 may include any input device such as a button, a touch panel, a keyboard, or a switch.

The storage unit 43 stores various kinds of information. The storage unit 43 stores data in a predetermined storage medium and reads out data from the predetermined storage medium. Examples of the predetermined storage medium include a non-volatile storage medium such as a flash memory. For example, the storage unit 43 stores recording data.

The control unit 44 functions as an arithmetic processing device and controls an overall operation of the recording device 40 in accordance with a variety of programs. The control unit 44 is implemented, for example, by an electronic circuit such as a CPU (Central Processing Unit) or a DSP (Digital Signal Processor). It should be noted that the control unit 44 may include a ROM (Read Only Memory) that stores a program, an operation parameter, and the like to be used and a RAM (Random Access Memory) that temporarily stores a parameter and the like which appropriately change. The control unit 44 controls various kinds of processing for binaural recording.

### (4) Configuration of Control Device 6

FIG. 4 is a diagram illustrating an example of a configuration of the control device 6 according to the present embodiment. As illustrated in FIG. 4, the control device 6 includes a communication unit 61, a storage unit 62, and a control unit 63.

The communication unit 61 is a communication interface that communicates with another device in a wired or wireless manner. The communication unit 61 performs communication compliant with any communication standard. An example of the communication standard includes a LAN (Local Area Network), Wi-Fi (registered trademark), Bluetooth (registered trademark), a cellular communication standard such as 4G or 5G, a USB (Universal Serial Bus), or the like.

The storage unit 62 stores various kinds of information. The storage unit 62 stores data in a predetermined storage medium and reads out data from the predetermined storage medium. Examples of the predetermined storage medium include a non-volatile storage medium such as a flash memory. For example, the storage unit 62 stores various kinds of information such as measurement data, recording data, a correction coefficient, and corrected recording data.

The control unit 63 functions as an arithmetic processing device and controls an overall operation of the control device 6 in accordance with a variety of programs. The control unit 63 is implemented, for example, by an electronic circuit such as a CPU (Central Processing Unit) or a DSP (Digital Signal Processor). It should be noted that the control unit 63 may include a ROM (Read Only Memory) that stores a program, an operation parameter, and the like to be used and a RAM (Random Access Memory) that temporarily stores a parameter and the like which appropriately change. The control unit 63 controls processing of calculating transfer characteristics on the basis of measurement data and processing of correcting an audio signal on the basis of the calculated transfer characteristics.

### 2. Technical Features

### (1) Measurement of Transfer Characteristics

The signal processing system 1 measures transfer characteristics. Transfer characteristics are typically measured with the measurement earphones 10 and the measurement mics 20 worn on a human user. The transfer characteristics to be measured are the transfer characteristics from a sound source to the eardrums of a user (i.e., the acoustic characteristics of the transfer path). The signal processing system 1, however, measures the transfer characteristics from the measurement earphones 10 to the measurement mics 20 as an approximate value of the transfer characteristics from the sound source to the eardrums of the user. The acoustic characteristics may be frequency characteristics.

Each of the measurement mics 20 is disposed near an eardrum of a user. Meanwhile, each of the measurement earphones 10 is disposed at the auricle of the user. This configuration makes it possible to measure the acoustic characteristics of the auricle that have great influence on the way in which sound is transmitted to the eardrum. As an example, the measurement mic 20 may be disposed at an external auditory canal and the measurement earphone 10 may be disposed at a cavum concha. The user who wears the measurement earphones 10 and the measurement mics 20 to measure the transfer characteristics will be referred to as a user A below.

The measurement device 30 causes each of the measurement earphones 10 to reproduce a third audio signal. The measurement device 30 then transmits a fourth audio signal corresponding to the third audio signal reproduced by the measurement earphone 10 to the control device 6 as measurement data regarding the transfer characteristics. The fourth audio signal is acquired by the measurement mic 20. The third audio signal is an audio signal reproduced for the measurement of the transfer characteristics. The third audio signal may be a so-called sweep signal that gradually changes in frequency, for example, from a low frequency to a high frequency. The fourth audio signal can also be regarded as a third audio signal influenced by the transfer path from the measurement earphone 10 to the measurement mic 20.

If described in detail, the measurement device 30 first outputs a stored third audio signal to the measurement earphone 10 to cause the measurement earphone 10 to reproduce the third audio signal. The measurement mic 20 acquires a fourth audio signal that is an audio signal which is the third audio signal reproduced from the measurement earphone 10 and is derived from sound coming through the transfer path from the measurement earphone 10 to the measurement mic 20. The measurement device 30 then stores the fourth audio signal acquired by the measurement mic 20. After that, the measurement device 30 transmits the fourth audio signal to the control device 6 as measurement data.

The control device 6 calculates the transfer characteristics on the basis of the measurement data received from the measurement device 30. If described in detail, the control device 6 calculates the transfer characteristics on the basis of the third audio signal and the fourth audio signal. The calculated transfer characteristics correspond to the difference between the third audio signal and the fourth audio signal. Additionally, the third audio signal is assumed to be known to the control device 6.

The first terminal device 3 may receive and output information regarding the acquisition of the measurement data. For example, the first terminal device 3 transmits and receives control information to and from the measurement system 2, displays a UI screen for operating the measurement system 2, and receives an input of information about an instruction to start to acquire measurement data. The measurement device 30 may acquire the measurement data by being triggered by an input of information for an instruction to acquire the measurement data to the first terminal device 3. According to this configuration, it is possible to cause the first terminal device 3 to function as a UI of the measurement system 2.

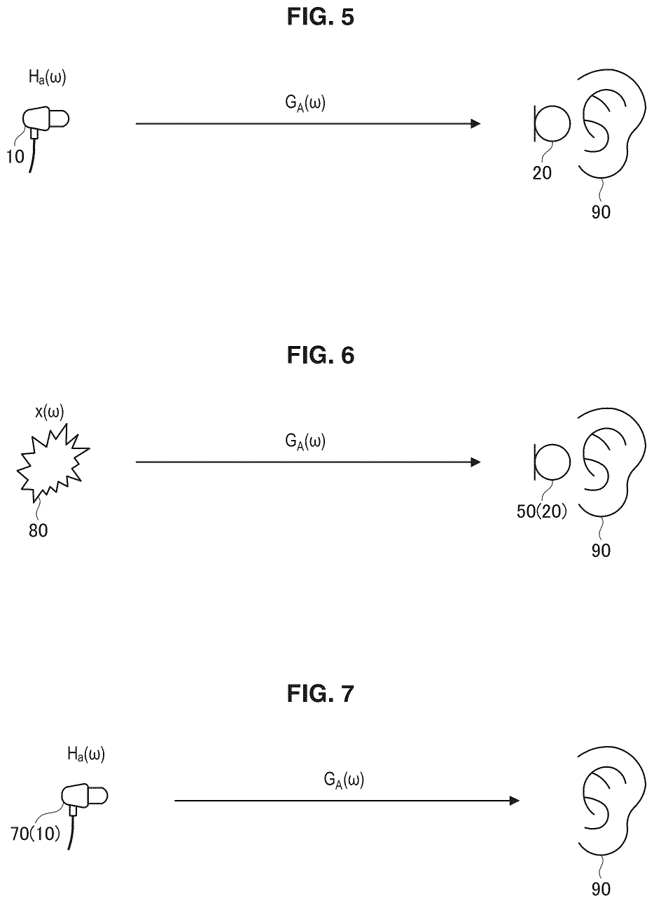

Specific processing of measuring transfer characteristics will be described with reference to FIG. 5.

FIG. 5 is a diagram for describing the measurement of transfer characteristics according to the present embodiment. As illustrated in FIG. 5, the transfer path from the measurement earphone 10 to the measurement mic 20 has the measurement earphone 10 and an auricle 90 of the user A wearing the measurement earphone 10 and the measurement mic 20. The transfer characteristics to be measured are therefore expressed by the following expression.

$$\begin{matrix}[ Math . 1 ] & \\ {G}_{m} ( ω ) = {G}_{A} ( ω ) {H}_{a} ( ω ) & ( 1 )\end{matrix}$$

Here, Gₘ(ω) represents the transfer characteristics. Hₐ(ω) represents the acoustic characteristics of the measurement earphone 10. It should be noted that the acoustic characteristics herein are, for example, magnitude-frequency characteristics. In addition, phase-frequency characteristics, phase delay characteristics, group delay characteristics, or the like may be adopted. G_{A}(ω) represents the acoustic characteristics of the auricle 90 of the user A. ω represents an angular frequency.

### (2) Binaural Recording

The recording system 4 performs binaural recording. Binaural recording is performed with the recording mics 50 worn on a user.

If described in detail, each of the recording mics 50 acquires a first audio signal derived from sound coming from a sound source that is a target of binaural recording. The recording device 40 then stores the first audio signal acquired by the recording mic 50. After that, the recording device 40 transmits the stored first audio signal to the control device 6 as recording data.

The control device 6 generates corrected recording data by correcting the recording data received from the recording device 40. If described in detail, the control device 6 corrects the first audio signal on the basis of the measurement data acquired by the measurement device 30 and generates a second audio signal. For example, the control device 6 generates a second audio signal by applying correction processing based on the transfer characteristics calculated on the basis of the measurement data to the first audio signal. After that, the control device 6 stores the generated second audio signal as corrected recording data. The second terminal device 5 may receive the second audio signal that is corrected recording data from the control device 6 and cause each of the reproduction earphones to binaurally reproduce the second audio signal. The binaural reproduction of the second audio signal makes it possible to increase the quality of binaural reproduction in comparison with the binaural reproduction of the first audio signal. In this way, according to the present embodiment, it is possible to make a correction for increasing the quality of binaural reproduction in advance at the time of binaural recording.

It is desirable that a user who wears the recording mics 50 at the time of binaural recording and a user who wears the measurement earphones 10 and the measurement mics 20 at the time of the measurement of the transfer characteristics be the same. Further, it is desirable that the disposition of the recording mics 50 at the time of binaural recording and the disposition of the measurement mics 20 at the time of the measurement of the transfer characteristics be the same. Further, it is desirable that the acoustic characteristics of the measurement mic 20 be the same as the acoustic characteristics of the recording mic 50. In a case where these conditions are all satisfied, it is possible to maximize the correction effects and increase the quality of binaural reproduction. Needless to say, even if at least any one of these conditions is not satisfied, it is possible to increase the quality of binaural reproduction. It will be assumed below that binaural recording is performed with the user A in the same disposition as the disposition at the time of the measurement of the transfer characteristics and with the user A wearing the recording mics 50 having the same acoustic characteristics as those of the measurement mics 20.

Binaural recording will be described with reference to FIG. 6.

FIG. 6 is a diagram for describing binaural recording according to the present embodiment. As illustrated in FIG. 6, the transfer path from a sound source 80 that is a target of binaural recording to the recording mic 50 having the same acoustic characteristics as those of the measurement mic 20 has the auricle 90 of the user A wearing the recording mic 50. A first audio signal to be acquired by the recording mic 50 is therefore expressed by the following expression.

$$\begin{matrix}[ Math . 2 ] & \\ {y}_{rec} ( ω ) = {G}_{A} ( ω ) x ( ω ) & ( 2 )\end{matrix}$$

Here, y_{rec}(ω) represents the first audio signal. x(ω) represents an audio signal (also referred to as a sound source signal below) derived from sound generated from the sound source 80.

The control device 6 generates a second audio signal by correcting the first audio signal on the basis of the transfer characteristics measured in advance. Specifically, the control device 6 generates a second audio signal by convolving the inverse characteristics of the transfer characteristics Gₘ(ω) measured in advance with the first audio signal y_{rec}(ω). The second audio signal is expressed by the following expression.

$$\begin{matrix}[ Math . 3 ] & \\ {y}^{′} ( ω ) = {y}_{rec} ( ω ) {G}_{m}^{- 1} ( ω ) = {G}_{A} ( ω ) {G}_{A}^{- 1} ( ω ) {H}_{a}^{- 1} ( ω ) x ( ω ) = {H}_{a}^{- 1} ( ω ) x ( ω ) & ( 3 )\end{matrix}$$

Here, y′(ω) represents the second audio signal. Gₘ⁻¹(ω) represents the inverse characteristics of the transfer characteristics Gₘ(ω). Hₐ⁻¹(ω) represents the inverse characteristics of the acoustic characteristics Hₐ(ω) of the measurement earphone 10. The inverse characteristics Gₘ⁻¹(ω) of the transfer characteristics Gₘ(ω) will also be referred to as a correction coefficient below.

As indicated in Expression (3), the second audio signal y′(ω) is the sound source signal x(ω) with which the inverse characteristics Hₐ⁻¹(ω) of the acoustic characteristics Hₐ(ω) of the measurement earphone 10 are convolved in advance. In addition, in the second audio signal y′(ω), the acoustic characteristics G_{A}(ω) of the auricle 90 of the user A are cancelled. This makes it possible to increase the quality of binaural reproduction without making a correction for cancelling the acoustic characteristics G_{A}(ω) of the auricles 90 of the user A or cancelling the acoustic characteristics Hₐ(ω) of the measurement earphones 10 at the time of binaural reproduction.

The correction is not necessary at the time of binaural reproduction. This makes it possible to significantly reduce the processing load on the whole of a system that distributes binaurally recorded content to a large number of second terminal devices 5 in real time. In addition, in a case where the correction is made at the time of binaural reproduction, it may be necessary to distribute metainformation for the correction along with the binaurally recorded content. In this regard, according to the present embodiment, it is possible to eliminate the necessity to distribute the metainformation for the correction. This makes it possible to significantly reduce even the communication load. It should be noted that the metainformation for the correction may include the acoustic characteristics G_{A}(ω) of the auricle 90 of the user A, the acoustic characteristics Hₐ(ω) of the measurement earphone 10, and the like.

In addition, according to the present embodiment, binaural recording is performed with the recording mics 50 worn on the human user A. This makes it possible to perform simple and high-quality binaural recording in a variety of use cases in comparison with binaural recording performed by using a dummy head. For example, it is possible to perform binaural recording with the recording mics 50 worn on a user who is capturing a moving image while moving with a camera in a hand. In addition, it is also possible for a user to perform binaural recording and monitor the binaural recording (i.e., check recorded sound) at the same time.

### (3) Binaural Reproduction

Binaural reproduction is performed with the reproduction earphones worn on a user. A configuration of each of the reproduction earphones may be similar to that of the measurement earphone 10. Each of the reproduction earphones is disposed at the auricle of the user. As an example, the reproduction earphone may be disposed at the cavum concha. The reproduction earphone reproduces a second audio signal while disposed at the auricle of the user. This allows a user wearing the reproduction earphones to listen to the binaurally recorded sound.

A user who wears the recording mics 50 at the time of binaural recording and a user who wears the reproduction earphones at the time of binaural reproduction may be the same. That is, binaural reproduction may be performed with the user A wearing the reproduction earphones. Meanwhile, the user who wears the recording mics 50 at the time of binaural recording and the user who wears the reproduction earphones at the time of binaural reproduction may be different. That is, binaural reproduction may be performed with a user B wearing the reproduction earphones. The user B is different from the user A.

In addition, the acoustic characteristics of the measurement earphone 10 and the acoustic characteristics of the reproduction earphone may be the same or different.

The following describes sounds to which a user listens when binaurally recorded content is binaurally reproduced in three types of reproduction environments.

### —First Reproduction Environment

A first reproduction environment is a reproduction environment in which the acoustic characteristics of the measurement earphones 10 and the acoustic characteristics of the reproduction earphones are the same and the reproduction earphones are worn by the user A. Binaural reproduction in the first reproduction environment will be described with reference to FIG. 7.

FIG. 7 is a diagram for describing binaural reproduction according to the present embodiment. As illustrated in FIG. 7, the transfer path from a reproduction earphone 70 having the same acoustic characteristics as those of the measurement earphone 10 to an eardrum of the user A has the auricle 90 of the user A wearing the reproduction earphone 70. An audio signal indicating sound to which the user A listens is therefore expressed by the following expression.

$$\begin{matrix}[ Math . 4 ] & \\ {y}_{r e p} ( ω ) = {G}_{A} ( ω ) {H}_{a} ( ω ) {y}^{′} ( ω ) = {G}_{A} ( ω ) x ( ω ) = {y}_{r e c} ( ω ) & ( 4 )\end{matrix}$$

Here, yᵣₑₚ(ω) represents an audio signal indicating sound to which a user wearing the reproduction earphone 70, that is, the user A listens. Hₐ(ω) represents the acoustic characteristics of the reproduction earphone 70 that are the same as the acoustic characteristics of the measurement earphone 10.

As indicated in Expression (4), it is possible for the user A to listen to the first audio signal y_{rec}(ω). That is, it is possible for the user A to listen to the same sounds as the sounds at the time of binaural recording. In this way, it is possible to increase the quality of binaural reproduction.

### —Second Reproduction Environment

A second reproduction environment is a reproduction environment in which the acoustic characteristics of the measurement earphones 10 and the acoustic characteristics of the reproduction earphones 70 are the same and the reproduction earphones 70 are worn by the user B different from the user A.

In this reproduction environment, the transfer path from the reproduction earphone 70 having the same acoustic characteristics as those of the measurement earphone 10 to an eardrum of the user B has the auricle 90 of the user B wearing the reproduction earphone 70. An audio signal indicating sound to which the user B listens is therefore expressed by the following expression.

$$\begin{matrix}[ Math . 5 ] & \\ {y}_{r e p} ( ω ) = {G}_{B} ( ω ) {H}_{a} ( ω ) {y}^{′} ( ω ) = {G}_{B} ( ω ) x ( ω ) & ( 5 )\end{matrix}$$

Here, yᵣₑₚ(ω) represents an audio signal indicating sound to which a user wearing the reproduction earphone 70, that is, the user B listens. Hₐ(ω) represents the acoustic characteristics of the reproduction earphone 70 that are the same as the acoustic characteristics of the measurement earphone 10. GB (ω) represents the acoustic characteristics of the auricle 90 of the user B.

Expression (2) shows that the audio signal y_{rec}(ω) indicating each of sounds to which the user A listens at the time of binaural recording is obtained by convolving the acoustic characteristics G_{A}(ω) of the auricle 90 of the user A with the sound source signal x(ω). In contrast, expression (5) shows that the audio signal yᵣₑₚ(ω) indicating each of sounds to which the user B listens at the time of binaural reproduction is obtained by convolving the acoustic characteristics GB (ω) of the auricle 90 of the user B with the sound source signal x(ω). That is, in a case where binaural recording is performed with the user B wearing the recording mics 50 instead of the user A, it is possible for the user B to listen to an audio signal indicating each of sounds to which the user B is to listen in the place of binaural reproduction. In this way, it is possible for the user B to listen to sounds that make the user B feel as if the user B was present in the place of binaural recording instead of the user A. In this way, it is possible to increase the quality of binaural reproduction.

The binaurally recorded sound source signals x(ω) may, however, include the influence of acoustic characteristics specific to the user A in addition to the acoustic characteristics of the auricles 90 of the user A. Such acoustic characteristics include acoustic characteristics caused by physical characteristics of the user A other than the auricles 90. The audio signal yᵣₑₚ(ω) indicating each of sounds to which the user B listens includes the influence of acoustic characteristics specific to the other user A. This may impair aural naturalness.

However, in a case where binaural recording is performed with the recording mics 50 worn on the ears of a human, it is possible to increase the quality of binaural reproduction in comparison with binaural recording performed with the recording mics 50 worn on a dummy head. This is because, in a case where binaural recording is performed with the recording mics 50 worn on a dummy head, the audio signal yᵣₑₚ(ω) indicating each of sounds to which the user B listens includes the acoustic characteristics of the dummy head. In that case, the sound reflection coefficient different from that of human skin and the influence of a structure different from a human body impair aural naturalness.

### —Third Reproduction Environment

A third reproduction environment is a reproduction environment in which the acoustic characteristics of the measurement earphones 10 and the acoustic characteristics of the reproduction earphones 70 are different and the reproduction earphones 70 are worn by the user B different from the user A.

In this reproduction environment, the transfer path from the reproduction earphone 70 having different acoustic characteristics from those of the measurement earphone 10 to an eardrum of the user B has the auricle 90 of the user B wearing the reproduction earphone 70. An audio signal indicating sound to which the user B listens is therefore expressed by the following expression.

$$\begin{matrix}[ Math . 6 ] & \\ {y}_{r e p} ( ω ) = {G}_{B} ( ω ) {H}_{n} ( ω ) {y}^{′} ( ω ) = {G}_{B} ( ω ) \frac{{H}_{n} ( ω )}{{H}_{a} ( ω )} x ( ω ) & ( 6 )\end{matrix}$$

Here, yᵣₑₚ(ω) represents an audio signal indicating sound to which a user wearing the reproduction earphone 70, that is, the user B listens. Hₙ(ω) represents the acoustic characteristics of the reproduction earphone 70 that are different from the acoustic characteristics of the measurement earphone 10. GB (ω) represents the acoustic characteristics of the auricle 90 of the user B.

Expression (6) shows that the user B listens to sounds each obtained by convolving acoustic characteristics Hₙ(ω)/Hₐ(ω) corresponding to the difference between the measurement earphone 10 and the reproduction earphone 70 with an audio signal indicating each of sounds to which the user B listens in the second reproduction environment described above. That is, in a case where binaural recording is performed with the user B wearing the recording mics 50 instead of the user A, it is possible for the user B to listen to sound similar each of sounds to which the user B is to listen in the place of binaural reproduction. An increase in the quality of binaural reproduction is therefore expected.

### (4) Flow of Processing

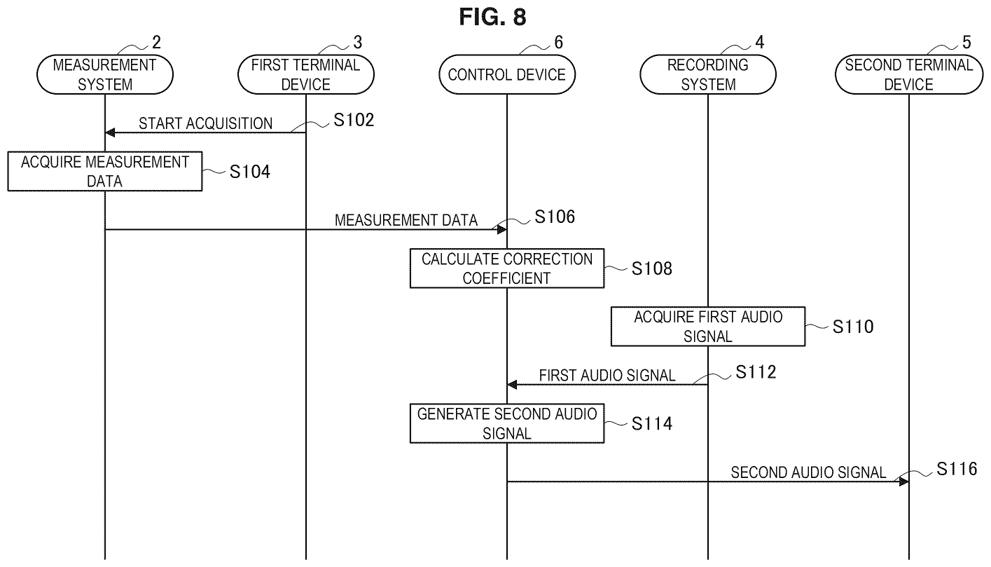

An example of a flow of processing related to the measurement of transfer characteristics and binaural recording will be described below with reference to FIG. 8. FIG. 8 is a sequence diagram illustrating an example of a flow of processing that is executed by the signal processing system 1 according to the present embodiment. The measurement system 2, the first terminal device 3, the recording system 4, the second terminal device 5, and the control device 6 are involved in this sequence.

As illustrated in FIG. 8, the first terminal device 3 first transmits, to the measurement system 2, a signal that requests a start to acquire measurement data (step S102). For example, in a case where a predetermined touch operation is inputted to a displayed UI screen, the first terminal device 3 transmits a signal that requests a start to acquire measurement data.

Subsequently, the measurement system 2 acquires measurement data (step S104). For example, the measurement device 30 causes the measurement earphone 10 to reproduce a third audio signal and causes the measurement mic 20 to acquire a fourth audio signal.

Next, the measurement system 2 transmits the measurement data to the control device 6 (step S106). For example, the measurement system 2 transmits the fourth audio signal to the control device 6 through cellular communication.

Subsequently, the control device 6 calculates a correction coefficient (step S108). For example, the control device 6 calculates the transfer characteristics on the basis of the known third audio signal and the fourth audio signal received from the measurement system 2. The control device 6 then calculates the inverse characteristics of the transfer characteristic as a correction coefficient. After that, the control device 6 stores the calculated correction coefficient.

Next, the recording system 4 acquires a first audio signal (step S110). For example, in a case where a predetermined user operation such as pushing down a button is inputted, the recording device 40 causes the recording mic 50 to acquire a first audio signal.

Subsequently, the recording system 4 transmits the first audio signal to the control device 6 (step S112). For example, the recording system 4 transmits the first audio signal to the control device 6 through cellular communication.

The control device 6 then generates a second audio signal by correcting the first audio signal (step S114). For example, the control device 6 generates the second audio signal by convolving a correction coefficient (i.e., the inverse characteristics of the transfer characteristics measured in advance) with the first audio signal.

Next, the control device 6 transmits the generated second audio signal to the second terminal device 5 (step S116). After that, the second terminal device 5 may store the received second audio signal, distribute the received second audio signal to another device, or cause the reproduction earphones 70 to perform binaural reproduction.

### (5) Effects

According to the embodiment described above, it is possible for a user to easily measure the transfer characteristics by wearing the measurement earphones 10 and the measurement mics 20 and causing third audio signals to be reproduced. In addition, it is possible for the user to easily perform binaural recording with high quality by just wearing the recording mics 50 and starting recording. This allows the user to acquire high-quality content even with no special knowledge of binaural recording. In this way, it is possible to perform binaural recording more easily.

In addition, the control device 6 executes correction processing having a high processing load such as calculating the transfer characteristics, calculating a correction coefficient, and convolving the correction coefficient. This makes it possible to reduce the processing load of the second terminal device 5 in comparison with correction processing executed by the second terminal device 5. In a case where binaurally recorded content is used by a plurality of users, that is, in a case where the plurality of second terminal devices 5 is present, the effects of reducing the processing load are prominent.

### <3. Hardware Configuration Example>

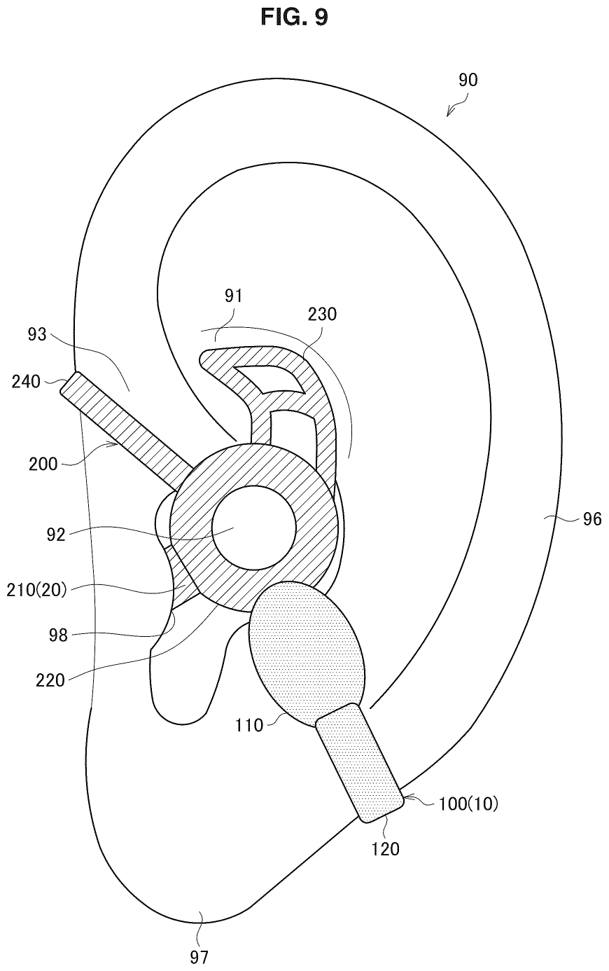

The measurement earphones 10 and the measurement mics 20 may be implemented by various kinds of hardware. An example thereof will be described with reference to FIG. 9.

FIG. 9 is a diagram schematically illustrating an example of a hardware configuration of the measurement earphone 10 and the measurement mic 20. As illustrated in FIG. 9, a headphone 100 serving as the measurement earphone 10 and a sound collection jig 200 including the measurement mic 20 are worn on the auricle 90 of a user.

### (1) Headphone 100

The headphone 100 is a sound output device that reproduces an audio signal. The headphone 100 is an example of the measurement earphone 10. The headphone 100 is configured in the shape of a so-called ear cuff. The headphone 100 is worn by a user to cover a part of the sound collection jig 200 worn on the user. The headphone 100 includes a driver unit 110 and a frame 120.

The driver unit 110 is a device that converts an inputted audio signal to sound and emits the sound to the surrounding space.

The frame 120 is a member that holds the driver unit 110 at the auricle 90. The frame 120 is curved to pass by the outside of at least any of a helix 96 or an earlobe 97 from the front surface of the auricle 90 to the back surface of the auricle 90 when the headphone 100 is worn by a user. The driver unit 110 is connected to an end of the frame 120. The frame 120 then clamps the auricle 90 from the front surface of the auricle 90 and the back surface of the auricle 90 with the driver unit 110 connected to the end of the frame 120 and the other end of the frame 120.

### (2) Sound Collection Jig 200

The sound collection jig 200 includes an insertion unit 210 including the measurement mic 20, a first frame 220, a second frame 230, and a third frame 240.

The insertion unit 210 is a member that is inserted to an external auditory canal 98 of a user. The insertion unit 210 is configured as a tubular body having a through hole that extends through the tubular body in the insertion direction. The measurement mic 20 is then disposed inside the through hole of the insertion unit 210 with a gap provided between the measurement mic 20 and the inner wall of the through hole. Once the insertion unit 210 is inserted to the external auditory canal 98 of a user, the measurement mic 20 is disposed near the eardrum of the user. Moreover, sound coming from the outside world passes through the through hole to reach the eardrum of the user. This allows the user to clearly listen to ambient sound when wearing the sound collection jig 200.

The first frame 220 is a member configured in the shape of a ring. The first frame 220 abuts a cavum concha 92 of a user when the sound collection jig 200 is worn by the user. The first frame 220 is connected to the insertion unit 210.

The second frame 230 is a member configured in the shape of a lightened shark fin. The second frame 230 abuts a cymba concha 91 of a user when the sound collection jig 200 is worn by the user. The second frame 230 is connected to the first frame 220.

The third frame 240 is curved to pass by the outside of a helical crus 93 of a user from the front surface of the auricle 90 of the user to the back surface of the auricle 90 when the sound collection jig 200 is worn by the user. The third frame 240 is connected to the first frame 220.

(3) Connection Mode with Measurement Device 30

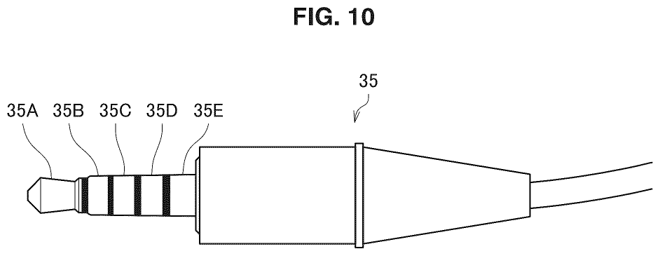

FIG. 10 is a diagram for describing an example of a connection mode between the measurement earphones 10 and the measurement mics 20, and the measurement device 30. As illustrated in FIG. 10, the two measurement earphones 10 and the two measurement mics 20, and the measurement device 30 may be connected in a wired manner through a 5-pole plug 35 including five terminals (35A to 35E). Two terminals (e.g., terminals 35A and 35B) of the 5-pole plug 35 transmit third audio signals that are inputted to the two measurement earphones 10. Two other terminals (e.g., terminals 35C and 35D) of the 5-pole plug 35 transmit fourth audio signals that are outputted from the two measurement mics 20. The one remaining terminal (e.g., terminal 35E) of the 5-pole plug 35 is a ground terminal. According to this configuration, it is possible to easily connect and disconnect the measurement earphones 10 and the measurement mics 20, and the measurement device 30.

Needless to say, at least any one of the measurement earphones 10 or the measurement mics 20 may be wirelessly connected to the measurement device 30.

### (4) Supplementary Information

The example of the hardware configuration of the measurement earphones 10 and the measurement mics 20 has been described above. According to the examples described above, it is possible to dispose the measurement earphone 10 at the auricle 90 of a user while inserting the measurement mic 20 to the external auditory canal 98 of the user and disposing the measurement mic 20 near the eardrum. In addition, it is possible to measure the transfer characteristics with the external auditory canals 98 of the user kept open.

A configuration of each of the recording mics 50 may be similar to that of the measurement mic 20. In that case, it is possible to perform binaural recording with the external auditory canals 98 of the user kept open.

A configuration of each of the reproduction earphones 70 may be similar to that of the measurement earphone 10.

It should be noted that the example has been described above in which the headphone 100 and the sound collection jig 200 are configured as different devices, but the present disclosure is not limited to this example. The headphone 100 and the sound collection jig 200 may be implemented as the same device. As an example, the first frame 220 may be provided with the driver unit 110. In other words, the measurement earphone 10 and the measurement mic 20 may be mounted on the same device.

### <4. Supplementary Information>

Heretofore, preferred embodiments of the present disclosure have been described in detail with reference to the appended drawings, but the present disclosure is not limited thereto. It should be understood by those skilled in the art that various changes and alterations may be made without departing from the spirit and scope of the appended claims.

### (1) First Modification Example

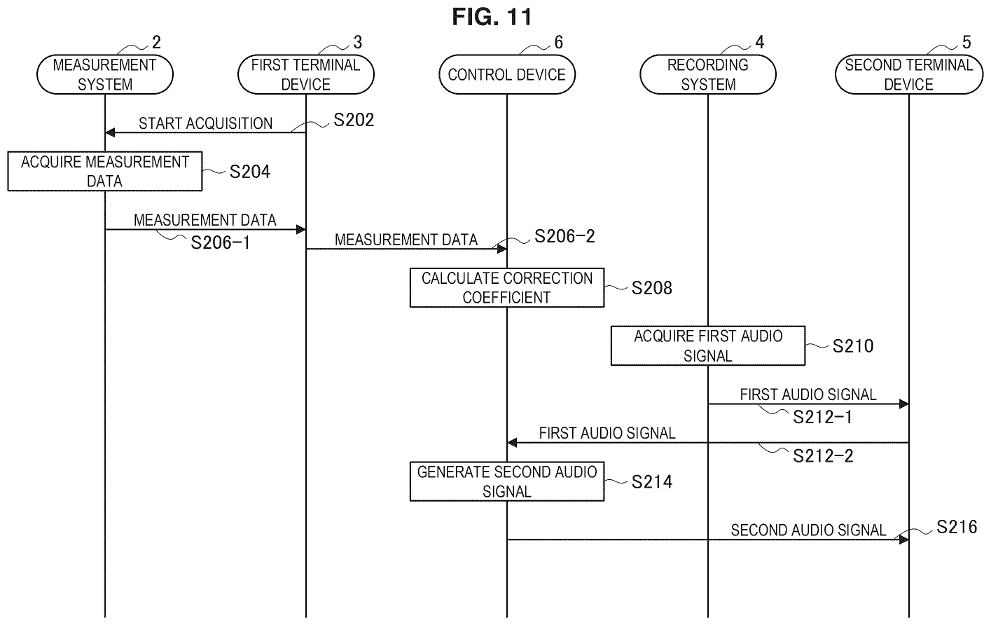

The measurement system 2 may communicate with the control device 6 through the first terminal device 3. For example, the measurement system 2 does not have to have a function of the third communication unit. Similarly, the recording system 4 may communicate with the control device 6 through the second terminal device 5. For example, the recording system 4 does not have to have a function of the third communication unit. An example of a flow of processing in that case will be described with reference to FIG. 11.

FIG. 11 is a sequence diagram illustrating an example of a flow of processing that is executed by the signal processing system 1 according to a first modification example. The measurement system 2, the first terminal device 3, the recording system 4, the second terminal device 5, and the control device 6 are involved in this sequence.

The processing according to step S202 and the processing according to step S204 illustrated in FIG. 9 are similar to the processing according to step S102 and the processing according to step S104 described above with reference to FIG. 8.

Subsequently, the measurement system 2 transmits the measurement data to the first terminal device 3 (step S206-1). Next, the first terminal device 3 transmits the received measurement data to the control device 6 (step S206-2).

The processing according to subsequent step S208 and the processing according to subsequent step S210 are similar to the processing according to step S108 and the processing according to step S110 described above with reference to FIG. 8.

Subsequently, the recording system 4 transmits the first audio signal to the second terminal device 5 (step S212-1). Next, the second terminal device 5 transmits the received first audio signal to the control device 6 (step S212-2).

The processing according to subsequent step S214 and the processing according to subsequent step S216 are similar to the processing according to step S114 and the processing according to step S116 described above with reference to FIG. 8.

### (2) Second Modification Example

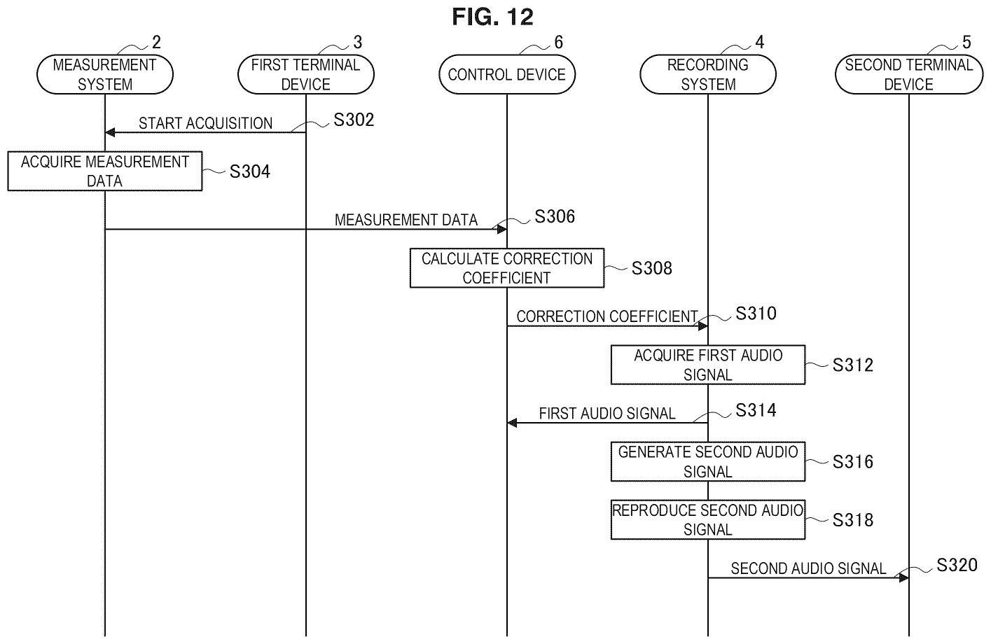

The recording system 4 may include the reproduction earphones 70. If described in detail, the recording device 40 may be connected to the reproduction earphones 70. In that case, it is possible for a user to perform binaural recording while causing the reproduction earphones 70 to reproduce binaurally recorded content and monitoring the binaurally recorded content. At that time, the recording device 40 may perform correction processing on the binaurally recorded content and then binaurally reproduce the content. An example of a flow of processing in that case will be described with reference to FIG. 12.

FIG. 12 is a sequence diagram illustrating an example of a flow of processing that is executed by the signal processing system 1 according to a second modification example. The measurement system 2, the first terminal device 3, the recording system 4, the second terminal device 5, and the control device 6 are involved in this sequence.

The processing according to step S302 to the processing according to step S308 illustrated in FIG. 12 are similar to the processing according to step S102 to the processing according to step S108 described above with reference to FIG. 8.

Subsequently, the control device 6 transmits a correction coefficient to the recording system 4 (step S310).

Next, the recording system 4 acquires a first audio signal (step S312). For example, in a case where a predetermined user operation such as pushing down a button is inputted, the recording device 40 brings the recording mic 50 into operation to acquire a first audio signal.

Subsequently, the recording system 4 transmits the first audio signal to the control device 6 (step S314). The control device 6 may store the received first audio signal for a backup.

Meanwhile, the recording system 4 generates a second audio signal by correcting the first audio signal (step S316). For example, the recording system 4 generates the second audio signal by convolving a correction coefficient (i.e., the inverse characteristics of the transfer characteristics measured in advance) received from the control device 6 with the first audio signal.

Next, the recording system 4 reproduces the second audio signal (step S318). For example, the recording device 40 causes each of the reproduction earphones 70 to reproduce the second audio signal.

Subsequently, the recording system 4 transmits the generated second audio signal to the second terminal device 5 (step S320).

It should be noted that the processing according to step S312 to the processing according to step S320 may be executed in order or executed in parallel at the same time.

### (3) Third Modification Example

The measurement device 30 may transmit information indicating the characteristics of the measurement earphone 10 to the control device 6 as measurement data. Examples of the information indicating the characteristics of the measurement earphone 10 include information indicating the acoustic characteristics of the measurement earphone 10, a setting value of the reproduction sound volume, and the like. The control device 6 calculates the transfer characteristics further on the basis of the characteristics of the measurement earphone 10. As a result, it is possible to increase the correction effects more and increase the quality of binaural reproduction.

The control device 6 may store the combination of the identification information about the measurement earphone 10 and the acoustic characteristics of the measurement earphone 10. In that case, the measurement device 30 may transmit the identification information about the measurement earphone 10 as information indicating the acoustic characteristics of the measurement earphone 10. It is possible for the control device 6 to search for the acoustic characteristics of the measurement earphone 10 by using the identification information received from the measurement device 30 as a search key and use a result of the search to calculate the transfer characteristics. According to this configuration, it is possible to reduce the communication load.

### (4) Fourth Modification Example

The measurement device 30 may transmit information indicating the characteristics of the measurement mic 20 to the control device 6 as measurement data. Examples of the information indicating the characteristics of the measurement mic 20 include information indicating the acoustic characteristics of the measurement mic 20, a setting value of the mic sensitivity, and the like. The control device 6 performs correction processing further on the basis of the characteristics of the measurement mic 20. As an example, the control device 6 adjusts the balance between the left and right measurement mics 20 on the basis of the mic sensitivities of the left and right measurement mics 20 and then calculates the transfer characteristics. As a result, it is possible to increase the correction effects more and increase the quality of binaural reproduction.

The control device 6 may store the combination of the identification information about the measurement mic 20 and the acoustic characteristics of the measurement mic 20. In that case, the measurement device 30 may transmit the identification information about the measurement mic 20 as information indicating the acoustic characteristics of the measurement mic 20. It is possible for the control device 6 to search for the acoustic characteristics of the measurement mic 20 by using the identification information received from the measurement device 30 as a search key and use a result of the search to calculate the transfer characteristics. According to this configuration, it is possible to reduce the communication load.

### (5) Fifth Modification Example

The recording device 40 may transmit information indicating the characteristics of the recording mic 50 to the control device 6 as recording data. Examples of the information indicating the characteristics of the recording mic 50 include information indicating the acoustic characteristics of the recording mic 50, a setting value of the mic sensitivity, and the like. The control device 6 adjusts a correcting coefficient further on the basis of the characteristics of the recording mic 50. As a result, it is possible to increase the correction effects more and increase the quality of binaural reproduction.

The control device 6 may store the combination of the identification information about the recording mic 50 and the acoustic characteristics of the recording mic 50. In that case, the recording device 40 may transmit the identification information about the recording mic 50 as information indicating the acoustic characteristics of the recording mic 50. It is possible for the control device 6 to search for the acoustic characteristics of the recording mic 50 by using the identification information received from the recording device 40 as a search key and use a result of the search for correction processing. According to this configuration, it is possible to reduce the communication load.

### (6) Sixth Modification Example

The measurement device 30 may transmit information indicating a method for the measurement mic 20 to acquire a fourth audio signal to the control device 6 as measurement data. The control device 6 calculates the transfer characteristics further on the basis of the information indicating the method for the measurement mic 20 to acquire a fourth audio signal. As a result, it is possible to increase the correction effects more and increase the quality of binaural reproduction.

As an example, the measurement device 30 may transmit the identification information about the third audio signal used to acquire the measurement data to the control device 6 as the information indicating the method for the measurement mic 20 to acquire a fourth audio signal. In this case, the control device 6 stores the combination of the identification information about the third audio signal and the third audio signal, searches for the third audio signal by using the identification information received from the measurement device 30 as a search key, and uses a result of the search to calculate the transfer characteristics.

As another example, the measurement device 30 may acquire a fourth audio signal once and transmit the fourth audio signal to the control device 6 as measurement data. Alternatively, the measurement device 30 may acquire fourth audio signals a plurality of times and transmit a result of the synchronous addition to the control device 6 as measurement data. In this case, the information indicating the method for the measurement mic 20 to acquire the fourth audio signals may include the number of times the fourth audio signals are subjected to synchronous addition.

### (7) Seventh Modification Example

The measurement device 30 may transmit a fifth audio signal acquired by the measurement mic 20 to the control device 6 as measurement data at a timing at which the measurement earphone 10 does not reproduce an audio signal. The control device 6 may then perform correction processing further on the basis of the fifth audio signal. If described in detail, the measurement device 30 causes the measurement mic 20 to record environmental sound and transmits a fifth audio signal corresponding to the environmental sound to the control device 6 as measurement data. In addition, the control device 6 cancels the component corresponding to the environmental sound indicated by the fifth audio signal from the fourth audio signal and then calculates the transfer characteristics. According to this configuration, it is possible to increase the accuracy of calculating the transfer characteristics. As a result, it is possible to increase the correction effects more and increase the quality of binaural reproduction.

### (8) Eighth Modification Example

The measurement device 30 may determine whether or not acquired measurement data satisfies a predetermined condition. In a case where the measurement device 30 supposes that it is possible to appropriately calculate the transfer characteristics from the acquired measurement data, the measurement device 30 determines that the predetermined condition is satisfied. If not, the measurement device 30 determines that the predetermined condition is not satisfied. As an example, the measurement device 30 determines whether or not the frequency characteristics of a fourth audio signal are within an appropriate frequency characteristic range. As another example, the measurement device 30 determines whether or not the noise level of a fourth audio signal is less than a predetermined threshold. As another example, the measurement device 30 determines whether or not a variation in fourth audio signals acquired a plurality of times is less than a predetermined threshold.

The measurement device 30 may transmit the measurement data alone that is determined to satisfy the predetermined condition to the control device 6. That is, the measurement device 30 transmits only the measurement data supposed to allow the transfer characteristics to be appropriately calculated to the control device 6. Needless to say, the control device 6 may make a determination about the predetermined condition described above. However, in a case where the measurement device 30 makes a determination about the predetermined condition described above, it is possible to reduce the communication load and reduce delay up to the re-acquisition of measurement data in comparison with a determination about the predetermined condition described above made by the control device 6.

In a case where the measurement device 30 determines that the measurement data does not satisfy the predetermined condition, the first terminal device 3 may prompt a user to re-acquire measurement data. At that time, the first terminal device 3 may output information indicating an action to be executed by the user before the acquisition of the measurement data. As an example, in a case where it is determined that the frequency characteristics of a fourth audio signal are out of the appropriate frequency characteristic range, the first terminal device 3 may display information that prompts a user to insert the 5-pole plug 35 again. As another example, in a case where it is determined that the noise level of a fourth audio signal is greater than or equal to the predetermined threshold, the first terminal device 3 may display information that prompts a user to move to a quiet place. As another example, in a case where it is determined that a variation in fourth audio signals acquired a plurality of times is greater than or equal to the predetermined threshold, the first terminal device 3 may display information that prompts a user to stand still. According to this configuration, it is possible to more easily acquire measurement data supposed to allow the transfer characteristics to be appropriately calculated.

In a case where an action to be executed by the user before the acquisition of the measurement data is not executed, the first terminal device 3 may refuse to receive the information for an instruction to start to acquire measurement data. As an example, the first terminal device 3 determines the height of the noise level by using a fifth audio signal acquired by the measurement mic 20 at a timing at which the measurement earphone 10 does not reproduce an audio signal. The first terminal device 3 then refuses to receive information for an instruction to start to acquire measurement data in a case where the noise level is greater than or equal to the predetermined threshold. For example, the first terminal device 3 may disable a button for an instruction to start to acquire measurement data in a UI screen. According to this configuration, it is possible to start to acquire measurement data only in a case where it is possible to acquire measurement data supposed to allow the transfer characteristics to be appropriately calculated.

### (9) Others

In the embodiment described above, the example has been described in which the measurement earphone 10 and the measurement mic 20 are worn by a human user, but the present disclosure is not limited to this example. The measurement earphone 10 and the measurement mic 20 may be worn on a dummy head.

In the embodiment described above, the example has been described in which the recording mic 50 is worn by a human user, but the present disclosure is not limited to this example. The recording mic 50 may be worn on a dummy head.

In the embodiment described above, the example has been described in which the acoustic characteristics of the measurement mic 20 and the acoustic characteristics of the recording mic 50 are the same, but the present disclosure is not limited to this example. The acoustic characteristics of the measurement mic 20 be different from the acoustic characteristics of the recording mic 50.

In the embodiment described above, the example has been illustrated in which the signal processing system 1 includes the two measurement earphones 10, the two measurement mics 20, and the two recording mics 50 for both respective ears, but the present disclosure is not limited to this example. The signal processing system 1 may include the one measurement earphone 10, the one measurement mic 20, and the one recording mic 50 for one of the ears. That is, the present disclosure is applicable to binaural recording is performed for one of the ears in addition to binaural recording for both of the ears.

In the embodiment described above, an audio signal has been demonstrated as an example of the measurement data, but the present disclosure is not limited to this example. Another example of the measurement data includes an image. For example, the signal processing system 1 may estimate the transfer characteristics on the basis of an image of an ear of a user. The image of an ear includes an image showing the internal structure of the ear such as an X-ray photograph in addition to an image showing the outer appearance of the ear. In addition, the signal processing system 1 may perform correction processing on the basis of the physical characteristics of a user other than an ear. That is, the transfer characteristics estimated by the signal processing system 1 on the basis of measurement data are not limited to the transfer characteristics of the space from a sound source to an eardrum of the user, but may include the transfer characteristics of the body of the user. The measurement data may then include, for example, an image showing the body of the user other than an ear.

Each of the devices described herein may be implemented as an individual device or some or all of the devices may be implemented as different devices or collectively implemented as one device. As an example, some of the functions of the measurement system 2, the first terminal device 3, the recording system 4, or the second terminal device 5 may be included in a device such as a server connected through the network 9 or the like. As another example, the control device 6 may be implemented not only by an individual device, but also by a plurality of devices. Specifically, some of the functions of the control device 6 may be distributed to the plurality of devices in the mesh network. As another example, the measurement device 30 and the first terminal device 3 may be integrally configured. In addition, the recording device 40 and the second terminal device 5 may be integrally configured. In addition, the recording device 40 and the recording mic 50 may be integrally configured.

It is to be noted that the process by each device described herein may be achieved by software, hardware, or a combination of software and hardware. A program constituting software is stored in advance, for example, in a storage medium (more specifically, a non-transitory computer-readable storage medium) provided inside or outside each device. When executed by a computer that controls each device described herein, for example, each program is loaded into a RAM and executed by a processing circuit such as CPU. The storage medium is, for example, a magnetic disk, an optical disc, a magneto-optical disk, a flash memory, or the like. In addition, the computer program may be distributed over a network, instead, without using a storage medium. In addition, the computer may be an integrated circuit for a specific application such as an ASIC, a general-purpose processor that executes a function by reading a software program, a computer on a server used for cloud computing, or the like. In addition, the process by each device described herein may be performed by a plurality of computers in a distributed manner.

Further, in the present specification, the processes described using the flowcharts and the sequence diagrams are not necessarily executed in the order illustrated in the drawings. Some processing steps may be executed in parallel. In addition, additional processing steps may be employed and some processing steps may be omitted.

### REFERENCE SIGNS LIST

1 signal processing system
2 measurement system
3 first terminal device
4 recording system
5 second terminal device
6 control device
9 network
10 (10A, 10B) measurement earphone
20 (20A, 20B) measurement mic
30 measurement device
31 communication unit
32 storage unit
33 control unit
40 recording device
41 communication unit
42 input unit
43 storage unit
44 control unit
50 (50A, 50B) recording mic
61 communication unit
62 storage unit
63 control unit
70 reproduction earphone
80 sound source
90 auricle

1. A signal processing system comprising:
a measurement device configured to acquire measurement data regarding a transfer characteristic;
a first acquisition device configured to acquire a first audio signal; and
a control device configured to be connected to each of the measurement device and the first acquisition device through a network, wherein
the control device corrects the first audio signal on a basis of the measurement data acquired by the measurement device and generates a second audio signal.

2. The signal processing system according to claim 1, further comprising:
a reproduction device configured to reproduce an audio signal; and
a second acquisition device configured to acquire an audio signal, wherein
the measurement device transmits a fourth audio signal corresponding to a third audio signal reproduced by the reproduction device to the control device as the measurement data, the fourth audio signal being acquired by the second acquisition device.

3. The signal processing system according to claim 2, wherein the measurement device transmits information indicating a characteristic of the reproduction device or information indicating a characteristic of the second acquisition device to the control device as the measurement data.

4. The signal processing system according to claim 2, wherein the measurement device transmits information indicating a method for the second acquisition device to acquire the fourth audio signal to the control device as the measurement data.

5. The signal processing system according to claim 2, comprising:
the two reproduction devices; and
the two second acquisition devices, wherein
the two reproduction devices and the two second acquisition devices, and the measurement device are connected in a wired manner through a 5-pole plug including two terminals that transmit the third audio signals which are inputted to the two reproduction devices, two terminals that transmit the fourth audio signals which are outputted from the two second acquisition devices, and one ground terminal.

6. The signal processing system according to claim 2, wherein
the measurement device transmits a fifth audio signal acquired by the second acquisition device to the control device as the measurement data at a timing at which the reproduction device does not reproduce an audio signal, and
the control device corrects the first audio signal further on a basis of the fifth audio signal.

7. The signal processing system according to claim 1, wherein the measurement device includes a communication interface capable of cellular communication and causes the communication interface to transmit the measurement data to the control device.

8. The signal processing system according to claim 1, wherein the measurement device determines whether or not the acquired measurement data satisfies a predetermined condition, and transmits only the measurement data determined to satisfy the predetermined condition to the control device.

9. The signal processing system according to claim 1, further comprising a terminal device capable of receiving an input of information made by a user and outputting information to the user, wherein
the terminal device receives and outputs information regarding acquisition of the measurement data, and
the measurement device acquires the measurement data by being triggered by an input of information for an instruction to acquire the measurement data to the terminal device.

10. The signal processing system according to claim 9, wherein the terminal device outputs information indicating an action to be executed by the user before the acquisition of the measurement data.

11. The signal processing system according to claim 9, wherein, in a case where an action to be executed by the user before the acquisition of the measurement data is not executed, the terminal device refuses to receive the information for the instruction to start to acquire the measurement data.

12. The signal processing system according to claim 1, wherein the control device generates the second audio signal by calculating the transfer characteristic on the basis of the measurement data and convolving an inverse characteristic of the calculated transfer characteristic with the first audio signal.

13. A signal processing method that is executed by a computer, the signal processing method comprising:
acquiring measurement data regarding a transfer characteristic through a network;
acquiring a first audio signal through the network, the first audio signal being acquired by a first acquisition device; and
correcting the first audio signal on a basis of the measurement data and generating a second audio signal.

14. A non-transitory computer readable medium having a program stored therein, the program for causing a computer to execute
acquiring measurement data regarding a transfer characteristic through a network,
acquiring a first audio signal through the network, the first audio signal being acquired by a first acquisition device, and
correcting the first audio signal on a basis of the measurement data and generating a second audio signal.
